(19) United States
(12) Patent Application Publication
(10) Pub. No.: US 2003/0210904 A1
(43) Pub. Date: Nov. 13, 2003

(54) Information acquisition system, information acquisition method, and image taking device

(76) Inventors: Hidenori Tatsumi, Higashihiroshima (JP); Eiji Ueda, Toyota-gun (JP); Toshitaka Hanaura, Hiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 10/426,685

(22) Filed: May 1, 2003

(30) Foreign Application Priority Data
May 9, 2002 (JP) 2002-134160

(51) Int. Cl. G03B 17/24

(52) U.S. Cl. 396/310

(57) ABSTRACT

To provide an information acquisition system that allows specific information related to an object item, etc., which is exhibited at an exhibition site, to be acquired concurrently with taking an image thereof by a picture taking device. An ID transmitter 30 provided to an object 20 transmits object ID that enables identification of the object. When an image of the object 20 is taken at a position where the object ID can be received, an image taking device 10 obtains the object ID together with the taken image. The image taking device 10 transmits the obtained object ID to an information server 40. The information server 40 returns source information (for example, a URL where information such as product performance and a price related to the object can be acquired) corresponding to the received object ID to the image taking device 10. The image taking device 10 stores the received source information together with the taken image. A user acquires related information of the object 20 using the source information (for example, downloads the related information from a website designated by the URL).

### BACKGROUND OF THE INVENTION

1. Field of the Invention

The present invention relates to information acquisition systems, information acquisition methods, and image taking devices. More particularly, the present invention relates to an information acquisition system and an information acquisition method thereof for acquiring information related to an object whose image has been taken and managing the acquired information together with the taken image, and an image taking device included in the above-described system having an information communication function.

2. Description of the Background Art

In recent years, an image taking device having an information communication function, such as a digital still camera and a camera-equipped mobile phone, has become prevalent. An image taken by the above-described image taking device is utilized in various manners. For example, people capture the image into a personal computer for generating an electric album, or send the image as an attachment of an e-mail message. In business situations, people frequently copy the image taken by the image taking device for pasting it in or attaching it to a business report or presentation materials. Furthermore, an exhibited object item (hereinafter, referred to as an object) is taken by the image taking device at an exhibition site, etc., and the taken image is later used in a presentation for showing it to a person who did not go to the exhibition site, for example.

The image taking device, in general, only provides an image of the object. Thus, if people desire to obtain information about a feature or a specification, etc., of the object whose image has been taken, they have to get a brochure including the above-described information, or ask a member of the exhibition staff for the information to take notes thereof, for example. Getting a brochure or asking a staff member for the information, however, can be rather burdensome if the objects whose images are to be taken increase in number. Therefore, it would be very convenient if information related to an object can be obtained while taking an image of the object.

Japanese Patent Laid-Open Publication No. H10-161227 (1998-161227) discloses a technique that realizes the above-described convenient feature. In the technique disclosed in this gazette, equipment for transmitting information related to each object is previously placed in the vicinity of the object so that an image taking device (camera) receives the related information (for example, name, place of origin, age, and sound of the animal) from the equipment when taking an image of the object (lion), and stores the received related information together with the taken image.

In the above-described technique, however, a lot of information directly related to the object is transmitted at a time to the image taking device, whereby each equipment has to include a large-capacity memory for storing the information. Also, if the related information needs to be changed, for example, on-site service is required for making a change in the contents of the memory due to the memory included in each equipment for storing the related information, which results in a time-consuming maintenance work.

### SUMMARY OF THE INVENTION

Therefore, an object of the present invention is to provide an information acquisition system, an information acquisition method, and an image taking device that use information indicating a source of related information as information provided to the image taking device and collectively manage the above-described information.

The present invention has the following features to attain the object mentioned above.

A first aspect of the present invention is directed to an information acquisition system that allows related information of an object, whose image has been taken, to be acquired from a predetermined information server. The information acquisition system of the first aspect includes at least one ID transmitter provided corresponding to at least one object for transmitting object identification information that enables unique identification of a corresponding object by a first communication method, and an image taking device operable to take an image of one object among the at least one object, receive the object identification information transmitted from the ID transmitter while the image of the one object is taken, and acquire related information of the taken object, by using the received object identification information, from the predetermined information server by a second communication method.

According to the first aspect, it is possible to acquire the related information of the taken object from the predetermined information server by using the object identification information transmitted from the ID transmitter. Only the object identification information is transmitted from each ID transmitter. Thus, the ID transmitter is required to have minimal amounts of memory suitable for storing only the object identification information.

In the first aspect, as long as the predetermined information server is connected to a predetermined network so as to be operable to communicate therewith, the image taking device can transmit the object identification information and a predetermined mail address of a user to the predetermined information server, and the predetermined information server can transmit the related information of the taken object to a device designated by the mail address via the network.

As such, it is possible to transmit the related information of the object to an arbitrary device such as a personal computer, or the like. This is effective in the case where the amount of the related information is greater than the remaining amount of memory of the image taking device, or in the case where it takes a lot of time to complete acquisition of the related information due to slow communication speed of the image taking device, for example. Also, a user is allowed to obtain a portion or the entire portion of the related information later.

Typically, the second communication method is performed by wireless communication with no directivity, and the first communication method is performed by infrared communication with directivity and a shorter communication distance compared to that of the second communication method. Alternatively, the second communication method is performed by wireless communication with no directivity, and the first communication method is performed by wireless communication with directivity and a shorter communication distance compared to that of the second communication method. Alternatively, the second communication method is performed by wireless communication with no directivity, and the first communication method is performed by wireless communication using a wireless tag, the wireless communication with no directivity and a shorter communication distance compared to that of the second communication method.

As such, the first communication method enables identification of a desired ID transmitter from among a plurality of ID transmitters by moving the image taking device. Also, the second communication method allows the image taking device to communicate with the information server at any time from the current position.

In the first aspect, the image taking device preferably causes a predetermined mark, which indicates that the object identification information has been received from the ID transmitter, to be displayed on a screen. Alternatively, the image taking device preferably causes predetermined information related to the object whose object identification information has been received from the ID transmitter to be displayed on a screen, and causes a user to input an instruction for selecting a piece of information from among the displayed information.

As such, it is possible to notify the user whether or not the image taking device has been moved to the position where the object identification information can be received. Furthermore, the user can use the notification for designating an arbitrary one object.

The image taking device receives the object identification information transmitted from the ID transmitter when an image taking button for capturing an object image is operated by the user. Thus, the user can obtain the image and the related information of the object at one time without much concern for an information acquisition operation by only pressing the image taking button of the image taking device.

Preferably, the object identification information is source information providing an information source on a network where information related to the object is able to be acquired by the second communication method. As such, the source information is acquired while the image of the object is taken. Thus, the image taking device is not required to have large amounts of memory for storing the related information of the object.

In the preferable structure of the information acquisition system according to the first aspect, the at least one ID transmitter includes a storage section operable to store the object identification information, and an information transmitting section operable to transmit the object identification information stored in the storage section to the image taking device by the first communication method. The image taking device includes an image obtaining section operable to take an image of a specific object in accordance with an image taking operation by a user, an information receiving section operable to receive the object identification information of the specific object whose image has been taken by the image obtaining section from the ID transmitter provided to the specific object, a request transmitting section operable to transmit the object identification information received by the information receiving section to the predetermined information server by the second communication method in accordance with a request from the user, and a response receiving section operable to receive a response to transmission of the object identification information from the predetermined information server. The predetermined information server includes a storage section operable to store the related information of the object corresponding to the object identification information, a request receiving section operable to receive the object identification information from the image taking device, and a response transmitting section operable to transmit the related information of the object corresponding to the object identification information received by the request receiving section to the image taking device by the second communication method.

According to the above-described structure, the predetermined information server collectively manages the related information of a plurality of objects, thereby realizing space saving, cost reduction, and easy maintenance required when the related information is changed.

A second aspect of the present invention is directed to an image taking device that allows related information of an object whose image has been taken to be acquired from a predetermined information server. The image taking device of the second aspect is operable to take an image of one object among at least one object, receive object identification information transmitted by a first communication method from an ID transmitter provided corresponding to the one object, which enables unique identification of an object, while the image of the one object is taken, and acquire related information of the taken object, by using the received object identification information, from the predetermined information server by a second communication method.

Typically, the image taking device includes an image obtaining section operable to take an image of a specific object in accordance with an image taking operation by a user, an information receiving section operable to receive the object identification information of the specific object whose image has been taken by the image obtaining section from the ID transmitter provided to the specific object by the first communication method, a request transmitting section operable to transmit the object identification information received by the information receiving section to the predetermined information server by the second communication method in accordance with a request from the user, and a response receiving section operable to receive the related information of the object corresponding to the object identification information from the predetermined information server by the second communication method.

According to the second aspect, the image taking device can acquire the related information of the taken object from the predetermined information server by using the object identification information transmitted from the ID transmitter.

A third aspect of the present invention is directed to an information acquisition method executed in a system including an image taking device having an object image taking function and a predetermined communication function, at least one ID transmitter provided corresponding to at least one object, the at least one ID transmitter storing object identification information that enables unique identification of a corresponding object and having a function of transmitting the object identification information, and an information server storing related information of the object corresponding to the object identification information and having a predetermined communication function. The information acquisition method of the third aspect includes a step of taking an image of a specific object by the image taking device in accordance with an image taking operation by a user, a step of receiving the object identification information by the image taking device from the ID transmitter provided corresponding to the specific object by a first communication method while the image of the specific object is taken at the step of taking an image, and a step of acquiring related information of the specific object, by using the received object identification information, by a second communication method from the information server by the image taking device in accordance with a request from the user.

A fourth aspect of the present invention is directed to a recording medium removably inserted into an image taking device that allows related information of an object whose image has been taken to be acquired from a predetermined information server. In the fourth aspect, the image taking device is operable to take an image of one object among at least one object, receive object identification information transmitted by a first communication method from an ID transmitter provided corresponding to the one object, which enables unique identification of an object, while the image of the one object is taken, and acquire related information of the one object, by using the received object identification information, from the predetermined information server by a second communication method, and the recording medium is operable to package image data of the one object whose image has been taken by the image taking device with the object identification information, and store the packaged image data and object identification information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of an information acquisition system according to a first embodiment of the present invention;

FIG. 2 is a block diagram showing the detailed structure of an image taking device 10;

FIG. 3 is a block diagram showing the detailed structure of an ID transmitter 30;

FIG. 4 is a block diagram showing the detailed structure of an information server 40;

FIG. 5 is an illustration of exemplary contents stored in an information storage section 402;

FIG. 6A is an illustration showing exemplary infrared rays transmitted from the ID transmitter 30, and FIG. 6B is an illustration showing exemplary wireless electric waves transmitted from the image taking device 10 and the information server 40;

FIG. 7 is a flowchart showing a procedure of an information acquisition method according to the first embodiment of the present invention;

FIG. 8 is an illustration showing an exemplary screen displayed on a display section 111 of the image taking device 10;

FIG. 9 is an illustration showing exemplary contents stored in a storage section 102 of the image taking device 10;

FIG. 10 is an illustration showing an exemplary communication sequence executed based on the information acquisition method according to the first embodiment;

FIG. 11 is a block diagram showing another detailed structure of the information server 40;

FIG. 12 is a block diagram showing the structure of an information acquisition system according to a second embodiment of the present invention;

FIG. 13 is a block diagram showing the detailed structure of an image taking device 50;

FIG. 14 is a block diagram showing the detailed structure of an ID receiver 60;

FIG. 15 is a block diagram showing the detailed structure of an information server 70;

FIG. 16 is a flowchart showing a procedure of an information acquisition method according to the second embodiment of the present invention;

FIG. 17 is a block diagram showing another structure of the information server 70;

FIG. 18 is an illustration for explaining an object identification method according to a third embodiment of the present invention;

FIGS. 19A to 19D are illustrations showing exemplary screens displayed on the display section 111 of the image taking device 10; and

FIG. 20 is a timing chart for explaining the object identification method according to the third embodiment of the present invention.

### DESCRIPTION OF THE PREFERRED EMBODIMENTS

Hereinafter, an information acquisition system and an information acquisition method of the present invention are described by assuming that an image taking device is a digital still camera and that an object whose image is to be taken is an item (for example, an automobile or a personal computer) exhibited at an exhibition site (for example, an auto show or an electronics show).

(First Embodiment)

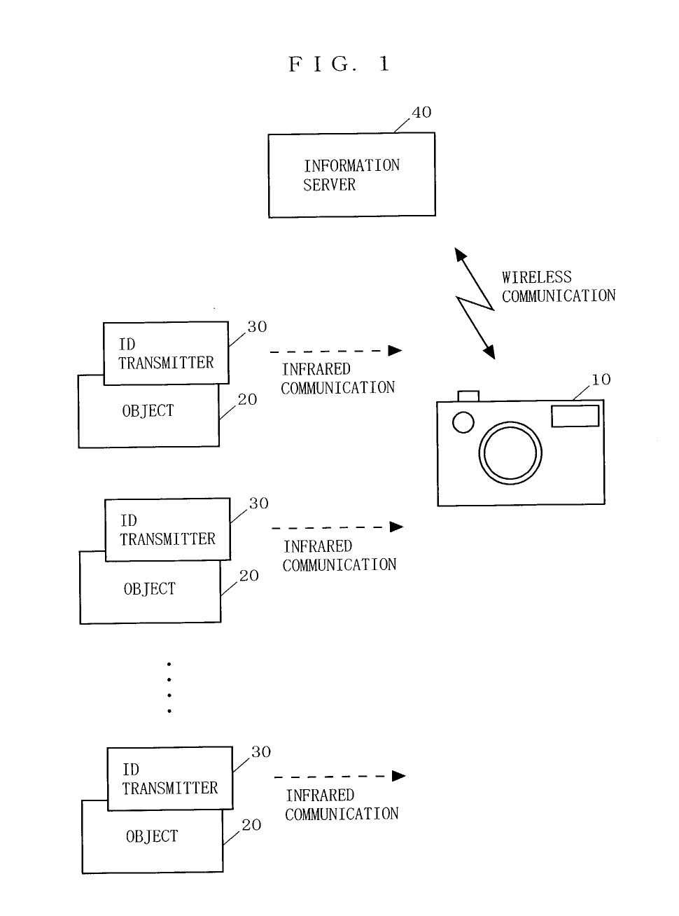

FIG. 1 is a block diagram showing the structure of an information acquisition system according to a first embodiment of the present invention. As shown in FIG. 1, the information acquisition system according to the first embodiment is composed of an image taking device 10, at least one object 20, and an information server 40. The object 20 is an exhibited item whose image is to be taken. The object 20 is provided with an ID transmitter 30. In this information acquisition system, infrared communication with directivity and a short communication distance (less than 10 m) is performed from the ID transmitter 30 to the image taking device 10, and bi-directional wireless communication with no directivity and a long communication distance (equal to or greater than 10 m) is performed between the image taking device 10 and the information server 40.

First, the image taking device 10, the ID transmitter 30, and the information server 10, which compose the information acquisition system according to the first embodiment, are each outlined.

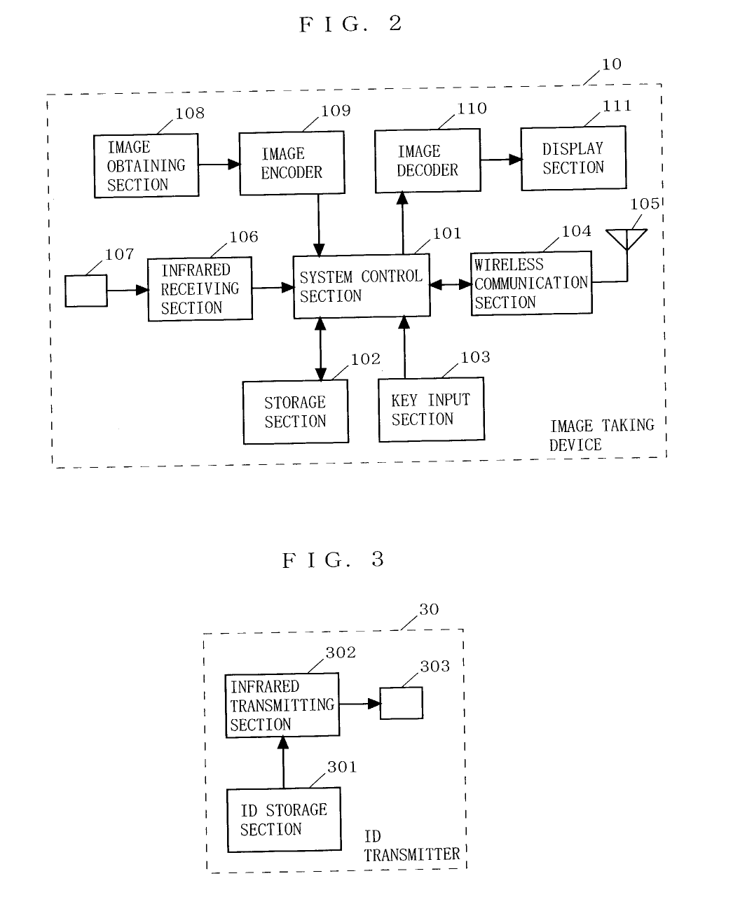

FIG. 2 is a block diagram showing the detailed structure of the image taking device 10 shown in FIG. 1. In FIG. 2, the image taking device 10 includes a system control section 101, a storage section 102, a key input section 103, a wireless communication section 104, a non-directivity antenna 105, an infrared receiving section 106, an infrared receiving element 107, an image obtaining section 108, an image encoder 109, an image decoder 110, and a display section 111.

In FIG. 2, the image obtaining section 108 obtains an image of the object 20 taken through an optical lens (not shown). The image encoder 109 performs predetermined encoding processing on the image obtained by the image obtaining section 108 for generating encoded image data. The image decoder 110 performs predetermined decoding processing on the encoded image data for decoding it into the taken image. The display section 111 displays the taken image decoded from the encoded image data by the image decoder 110 on a screen. The infrared receiving section 106 and the infrared receiving element 107 receive infrared rays sent from the ID transmitter 30, and extract predetermined object ID. The wireless communication section 104 and the non-directivity antenna 105 transmit the object ID to the information server 40, and receive predetermined information about a related information source therefrom by wireless communication. The storage section 102 stores the encoded image data generated by the image encoder 109 and the information about a related information source received by the wireless communication section 104. The storage section 102 may be a recording medium (for example, RAM) built into the image taking device 10, or may be a recording medium (for example, a memory card) removably inserted into the image taking device 10. The key input section 103 accepts instructions from a user for taking an image of the object or receiving the information about a related information source from the information server 40. The system control section 101 controls overall processing of the image taking device 10 by giving instructions to each component or causing information and data to be exchanged therebetween, for example.

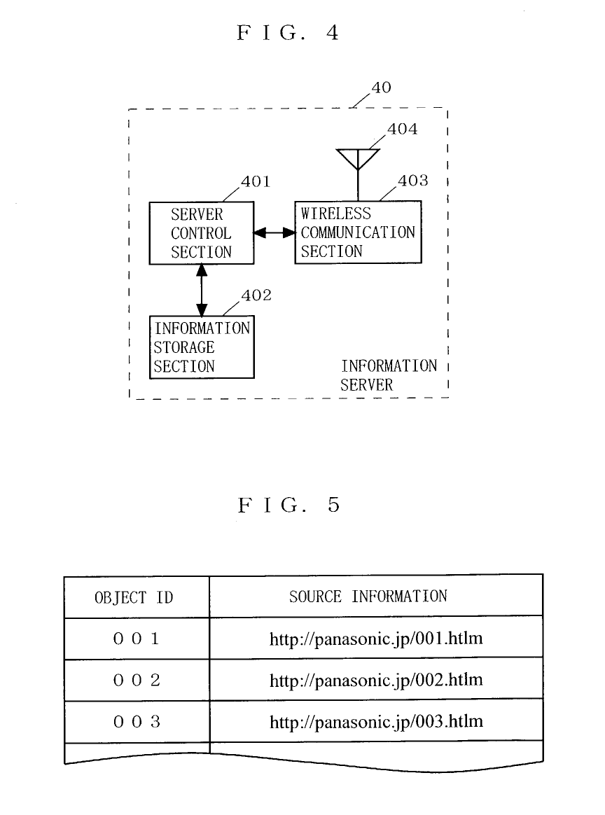

FIG. 3 is a block diagram showing the detailed structure of the ID transmitter 30 shown in FIG. 1. In FIG. 3, the ID transmitter 30 includes an ID storage section 301, an infrared transmitting section 302, and an infrared emitting element 303.

The ID storage section 301 stores object identification information (hereinafter, referred to as object ID) used for uniquely identifying the object 20 to which the ID transmitter 30 is provided. The object ID is uniquely provided to each object 20 in advance. The infrared transmitting section 302 and the infrared emitting element 303 convert the object ID stored in the ID storage section 301 into infrared rays for sending. The infrared rays maybe sent constantly or maybe sent regularly at predetermined intervals. Note that the ID transmitter 30 may be united with the object 20 or may be set independently in the vicinity of the object 20.

FIG. 4 is a block diagram showing the detailed structure of the information server 40 shown in FIG. 1. In FIG. 4, the information server 40 includes a server control section 401, an information storage section 402, a wireless communication section 403, and a non-directivity antenna 404.

The information storage section 402 stores, corresponding to each object ID, information about an information source (hereinafter, referred to as source information) where information such as product performance and a price related to the object 20 can be acquired. As the source information, a URL of a website introducing the object 20, and a broadcasting channel or a time frame of a television program showing the object 20 can be taken for an example. FIG. 5 is an illustration showing exemplary contents stored in the information storage section 402 if the source information is a URL. The server control section 401 receives the object ID from the image taking device 10, extracts the source information of the object ID from the information storage section 402, and returns the extracted information to the image taking device 10. In accordance with the instruction from the server control section 401, the wireless communication section 403 and the non-directivity antenna 404 receive the object ID from the image taking device 10 and transmit the source information thereto by wireless communication.

It is well known in the field of wireless communication that a predetermined identifier is attached to the object ID when it is transmitted from the image taking device 10 to the information server 40 for identifying the image taking device 10, and that the above-described predetermined identifier is attached to the source information when it is transmitted from the information server 40 to the image taking device 10. Thus, the detailed description thereof is omitted here. An identifier for identifying the image taking device 10 may be a device address, a wireless communication frequency, a frequency hopping pattern used in wireless communication in accordance with spread spectrum frequency hopping such as Bluetooth(R), and authentication information of the device, for example.

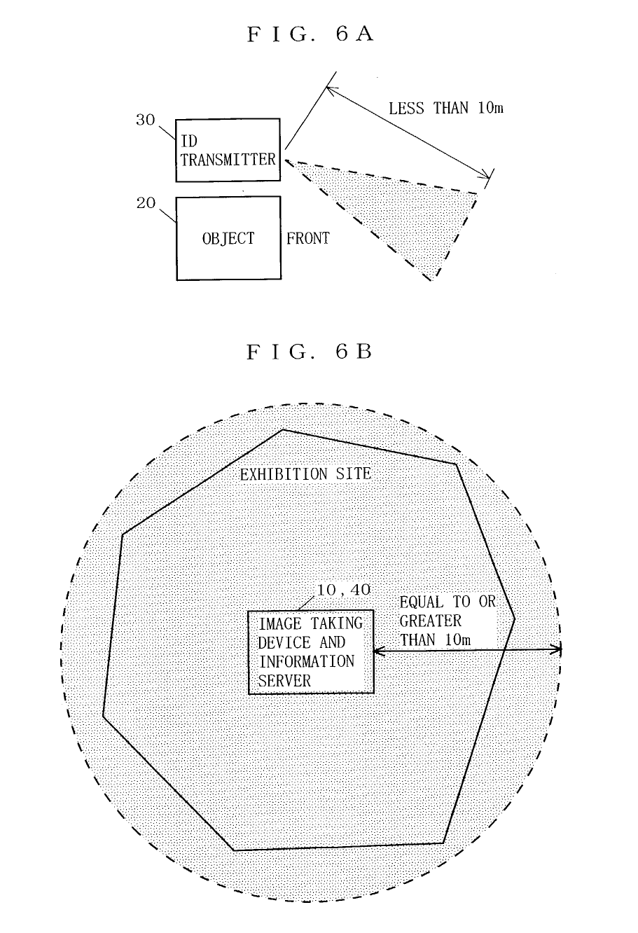

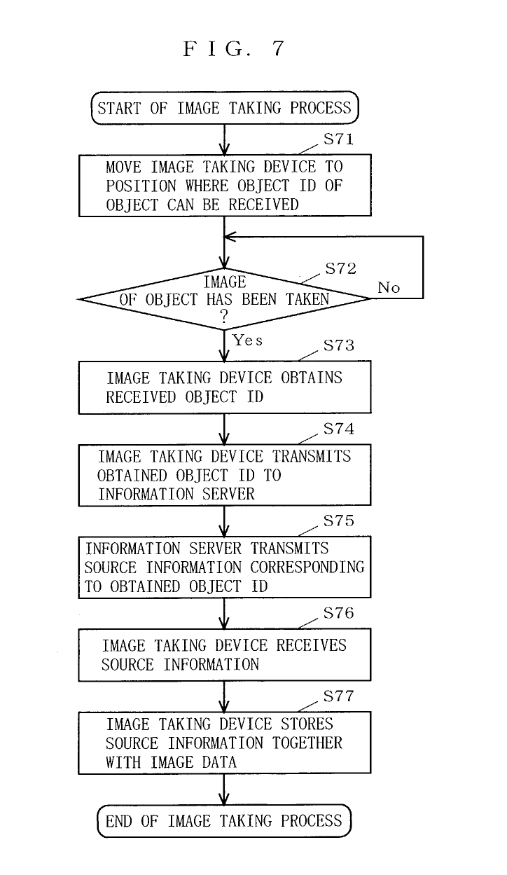

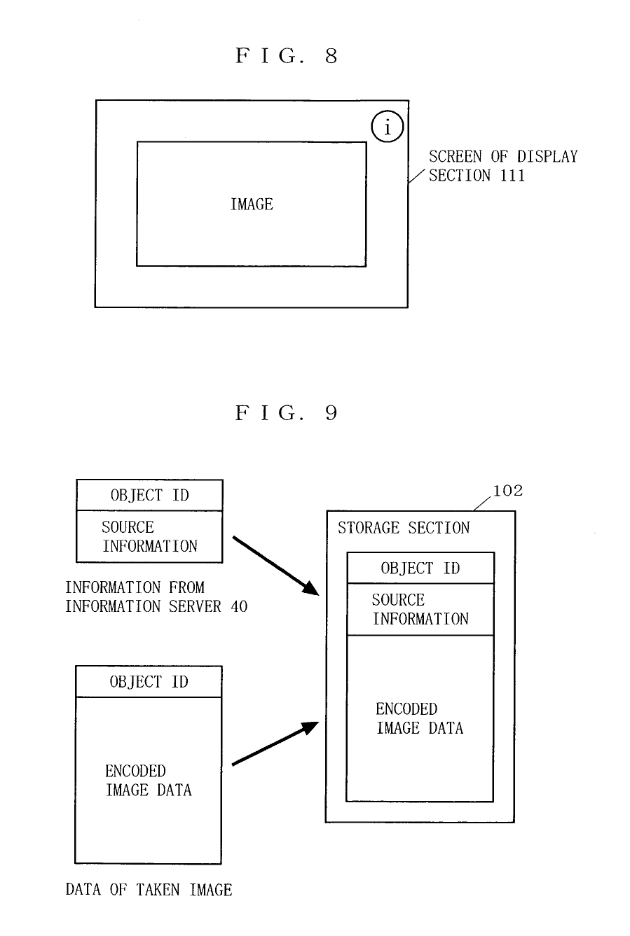

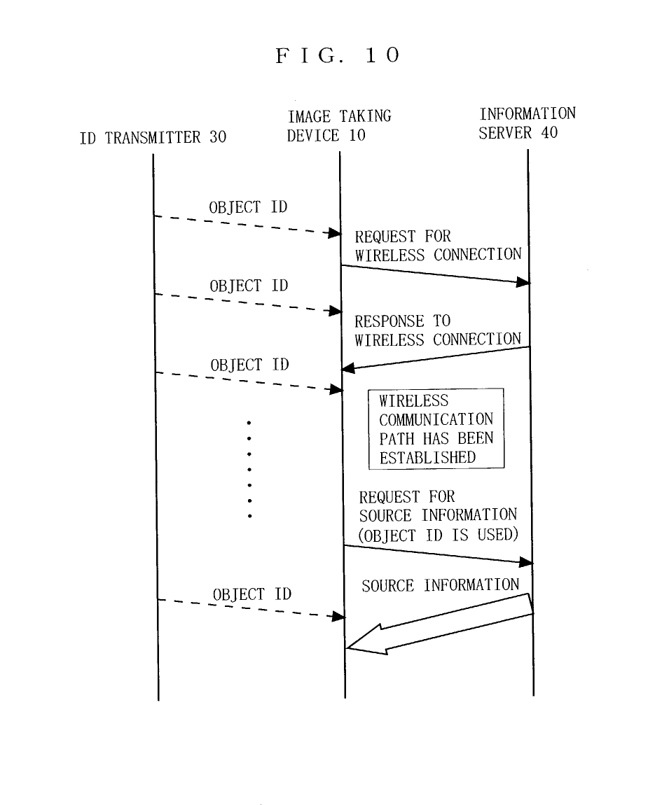

Next, an information acquisition method performed in the above-described information acquisition system according to the first embodiment is described. FIG. 6A is an illustration showing exemplary infrared rays transmitted from the ID transmitter 30, and FIG. 6B is an illustration showing exemplary wireless electric waves transmitted from the image taking device 10 and the information server 40. FIG. 7 is a flowchart showing a procedure of the information acquisition method according to the first embodiment of the present invention. FIG. 8 is an illustration showing an exemplary screen displayed on the display section 111 of the image taking device 10. FIG. 9 is an illustration showing exemplary contents stored in the storage section 102 of the image taking device 10. FIG. 10 is an illustration showing an exemplary communication sequence executed based on the information acquisition method according to the first embodiment.

As described above, the ID transmitter 30 uses the infrared rays with directivity and a short communication distance for transmitting the object ID to a predetermined area. The predetermined area is most preferably an area in front of the object 20 where most users are likely to stop for taking an image thereof (a shaded portion of FIG. 6A). The above-described infrared communication enables identification of a desired ID transmitter 30 from a plurality of ID transmitters 30 by moving the image taking device 10.

The image taking device 10 and the information server 40, on the other hand, realize bi-directional communication by using wireless electric waves with no directivity and a long communication distance. Preferably, the wireless electric waves have output intensity suitable for covering the entire area of the exhibition site (a shaded portion of FIG. 6B). This wireless communication allows the image taking device 10 to communicate with the information server 40 at any time from the current position.

A user carrying the image taking device 10 moves to the front of a specific object 20 for taking an image of the specific object 20, that is, the image taking device 10 is moved to a position where only the object ID transmitted from the ID transmitter 30 provided to the specific object 20 can be received (step S71). In this case, it is preferable to notify the user whether or not the image taking device 10 has been moved to the position where the object ID can be received. This notification maybe performed by displaying a predetermined mark “i” on the screen of the display section 111 of the image taking device 10 as shown in FIG. 8, or may be performed by producing a predetermined sound.

After moving to the position where the object ID can be received, the user performs an operation for taking an image of the object 20 (that is, the image of the object 20 has been taken at step S72). When the image of the object 20 is taken, the image taking device 10 concurrently obtains the object ID received from the ID transmitter 30 (step S73). Typically, it is automatically determined that the image of the object 20 is taken when an image taking button (shutter) of the image taking device 10 is pressed, and the object ID is obtained. After the object ID is obtained, the image taking device 10 transmits the obtained object ID to the information server 40 by wireless electric waves in response to a transmission request of the user (step S74). The transmission request of the user may be automatically provided concurrently with the operation for taking an image of the object 20, or may be additionally provided by the user manually after taking an image thereof. In the latter case, it is possible to collectively acquire the source information of a plurality of objects 20 whose images have already been taken. The information server 40 receives the object ID from the image taking device 10, and transmits the source information corresponding to the received object ID to the image taking device 10 (step S75).

The image taking device 10 receives the source information from the information server 40 (step S76), and associates the encoded image data of the taken image with the source information, that is, packages the encoded image data with the source information, for storing in the storage section 102 (step S77, FIG. 9). Source information stored after packaging processing as described above can be identified by only selecting an image corresponding thereto when it is later used in a personal computer, etc.

The source information acquired as described above is utilized, for example, as follows. If the source information is a URL and the image taking device 10 can be connected to the Internet, the image taking device 10 downloads the related information from the website designated by the URL. If the image taking device 10 cannot be connected to the Internet, a personal computer, etc., connected to the Internet downloads the related information from the website designated by the URL. If the source information is program information and the image taking device 10 can be connected to a program recording device, the image taking device 10 sets the program recording device to record a program.

In the above-described embodiment, the case where the object ID and the source information are transmitted and received without establishing a wireless communication path between the image taking device 10 and the information server 40 has been described. In this case, however, if the information server 40 fails to receive the object ID, or the image taking device 10 fails to receive the source information, the image taking device 10 is assumed to be unable to acquire the source information. Therefore, as shown in FIG. 10, the source information may be transmitted and received after the wireless communication path is established between the image taking device 10 and the information server 40.

As described above, in the information acquisition system and the information acquisition method according to the first embodiment of the present invention, only the object ID is transmitted from each ID transmitter 30. Thus, the ID transmitter 30 is required to have minimal amounts of memory suitable for storing only the object ID. Furthermore, the information server 40 does not store information directly related to the object 20, but stores information indicating a source where related information can be acquired, there by minimizing the amount of memory. Still further, the information server 40 collectively manages source information of a plurality of objects 20, thereby realizing space saving, cost reduction, and easy maintenance required when the source information is changed. Also, the source information is acquired when the image of the object 20 is taken. Thus, the user can obtain the related information later if the remaining amount of memory of the image taking device 10 is insufficient, for example.

Note that, in the above-described first embodiment, the case where the object ID is transmitted from the ID transmitter 30 to the image taking device 10 by infrared communication has been described, but the object ID may be transmitted by any form of wireless communication with directivity and a short communication distance. The above-described wireless communication can be easily realized by replacing the infrared transmitting section 302 and the infrared emitting element 303 of the ID transmitter 30 with a wireless communication section and a directivity antenna, respectively, and replacing the infrared receiving section 106 and the infrared receiving element 107 of the image taking device 10 with a wireless communication section and a directivity antenna, respectively. In this case, if the image taking device 10 is allowed to appropriately switch its antenna between the non-directivity antenna 105 and the directivity antenna and control the transmitting and receiving sensitivity thereof, a single wireless communication section is sufficient for the device. Thus, it is possible to realize reduction of size and cost of the image taking device 10. Alternatively, the object ID may be transmitted by any form of wireless communication with no directivity and a short communication distance. The above-described wireless communication can be realized by replacing the infrared transmitting section 302 and the infrared emitting element 303 of the ID transmitter 30 with a non-contact communication section composed of a wireless tag and a non-directivity antenna, respectively, and replacing the infrared receiving section 106 and the infrared receiving element 107 of the image taking device 10 with a non-contact communication section and a non-directivity antenna, respectively.

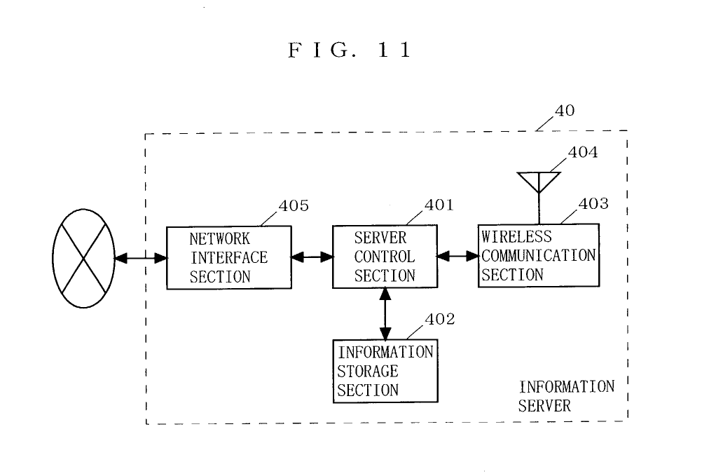

Furthermore, in the above-described first embodiment, the case where the information server 40 transmits the source information of the object 20 to the image taking device 10 has been described. As shown in FIG. 11, however, the following processing can be performed if the information server 40 is additionally provided with a network interface section 405 connecting the server control section 401 to a network.

After the image of the object 20 is taken, the image taking device 10 transmits a mail address of the user together with the object ID to the information server 40. The information server 40 receives the object ID and the mail address from the image taking device 10, and extracts the source information corresponding to the received object ID from the information storage section 402. Then, the information server 40 transmits the extracted source information to a device designated by the mail address via the network interface section 405. As a result, it is possible to transmit the source information to an arbitrary device such as a personal computer, or the like, via the network interface section 405. This is effective in the case where the amount of the related information is greater than the remaining amount of memory of the image taking device 10, or in the case where it takes a lot of time to complete acquisition of the related information due to slow communication speed of the image taking device 10, for example.

In the above-described first embodiment, the case where only the object ID is transmitted from the image taking device 10 to the information server 40 has been described. If a profile (for example, personal name, company name, and position) of the user of the image taking device 10 is additionally transmitted together with the object ID, the following advertising effects also can be obtained.

For example, it is possible to collect information about which object 20 interests a specific type of person (for example, a person doing a specific business at a specific company), which can be utilized in the future business operation. Furthermore, it is possible to computerize conventional business practices such as card exchanging at the exhibition site or an arrangement of the given business cards. Still further, the information server 40 can change the source information to be transmitted to the image taking device 10 or reject transmission of the source information based on the transmitted user's profile. For example, it is possible to block detailed information from being transmitted to a person of a rival company. Also, the information server 40 can charge for providing the source information based on the user's profile.

In the above-described first aspect, the image taking device 10 is assumed to acquire the source information from the information server 40 by using the object ID transmitted from the ID transmitter 30. However, the object ID transmitted from the ID transmitter 30 may be treated as the source information.

(Second Embodiment)

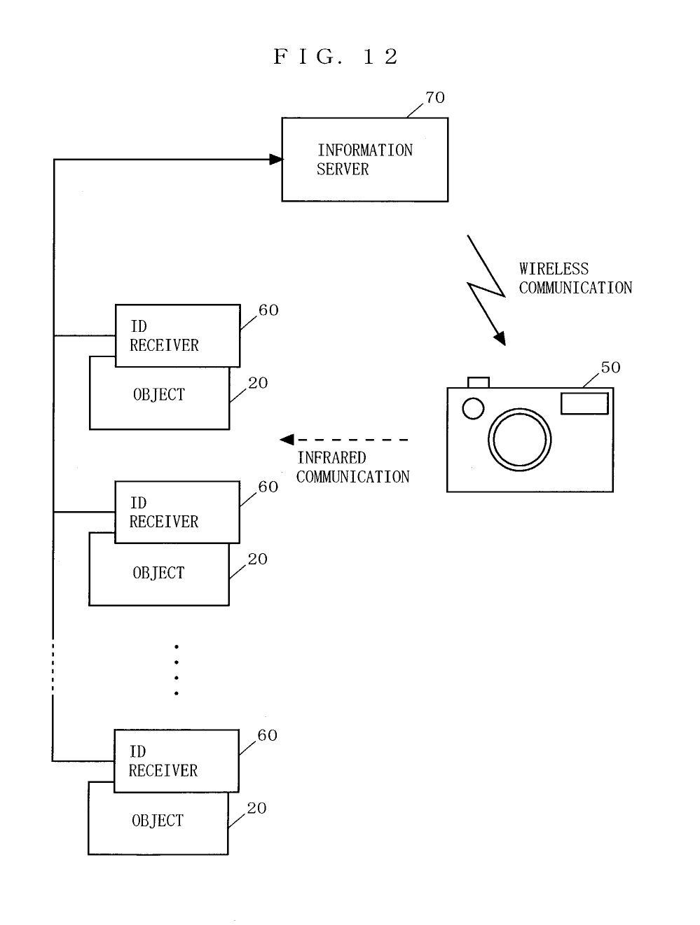

FIG. 12 is a block diagram showing the structure of an information acquisition system according to a second embodiment of the present invention. As shown in FIG. 12, the information acquisition system according to the second embodiment is composed of an image taking device 50, at least one object 20, and an information server 70. As aforementioned, the object 20 is an exhibited object item whose image is to be taken. The object 20 is provided with an ID receiver 60. In this system, infrared communication with directivity and a short communication distance (less than 10 m) is performed from the image taking device 50 to the ID receiver 60, and wireless communication with no directivity and a long communication distance (equal to or greater than 10 m) is performed from the information server 70 to the image taking device 50. Each ID receiver 60 is cable-connected to the information server 70.

First, the image taking device 50, the ID receiver 60, and the information server 70, which compose the information acquisition system according to the second embodiment, are each outlined.

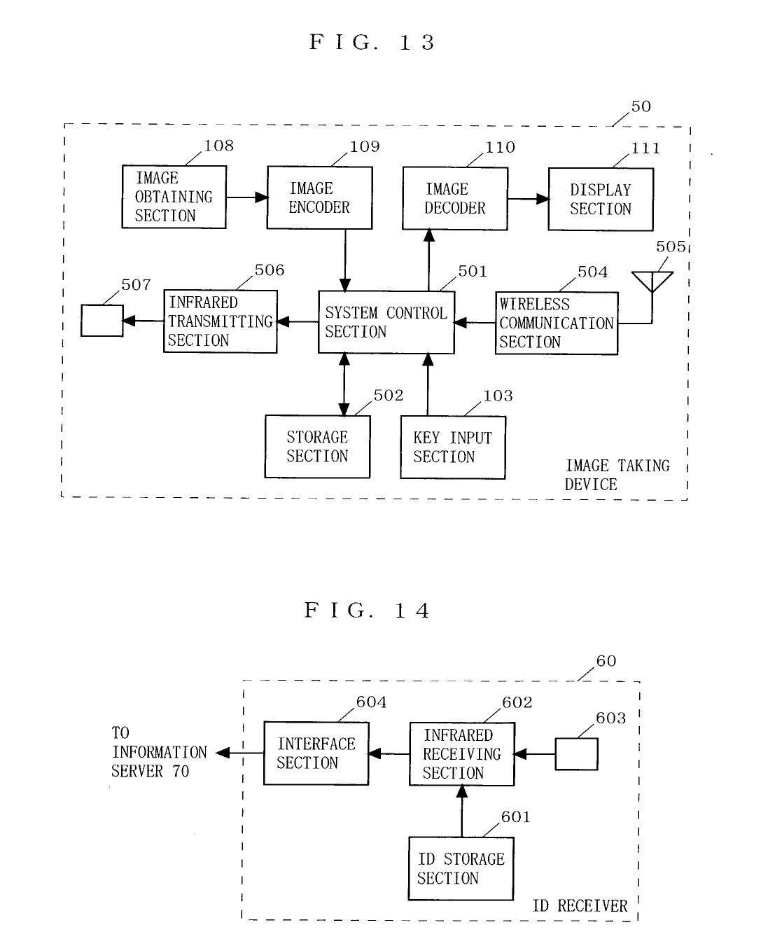

FIG. 13 is a block diagram showing the detailed structure of the image taking device 50 shown in FIG. 12. In FIG. 13, the image taking device 50 includes a system control section 501, a storage section 502, the key input section 103, a wireless communication section 504, a non-directivity antenna 505, an infrared transmitting section 506, an infrared emitting element 507, the image obtaining section 108, the image encoder 109, the image decoder 110, and the display section 111.

As shown in FIG. 13, the image taking device 50 of the second embodiment differs from the image taking device 10 of the first embodiment in that the system control section 501, the storage section 502, the wireless communication section 504, the non-directivity antenna 505, the infrared transmitting section 506, and the infrared emitting element 507 replace their counterparts of the image taking device 10. Herein after, the image taking device 50 is described, focusing on the above-described components different from their counterparts of the image taking device 10 of the first embodiment.

In FIG. 13, the storage section 502 stores encoded image data generated by the image encoder 109 and device identification information (hereinafter, referred to as device ID) used for uniquely identifying the image taking device 50. The infrared transmitting section 506 and the infrared emitting element 507 convert the device ID stored in the storage device 502 into infrared rays for sending. The infrared rays are sent when an image taking button of the image taking device 50 is pressed. The wireless communication section 504 and the non-directivity antenna 505 receive source information from the information server 70 by wireless communication. The system control section 501 controls overall processing of the image taking device 50 by giving instructions to each component or causing information and data to be exchanged therebetween, for example.

FIG. 14 is a block diagram showing the detailed structure of the ID receiver 60 shown in FIG. 12. In FIG. 14, the ID receiver 60 includes an ID storage section 601, an infrared receiving section 602, an infrared receiving element 603, and an interface section 604.

The ID storage section 601 stores the aforementioned object ID. The infrared receiving section 602 and the infrared receiving element 603 receive the infrared rays sent from the image taking device 50, and extract the device ID. The interface section 604 sends the device ID extracted by the infrared receiving section 602 together with the object ID stored in the ID storage section 601 to the information server 70. Note that the ID receiver 60 may be united with the object 20, or may be set independently in the vicinity of the object 20.

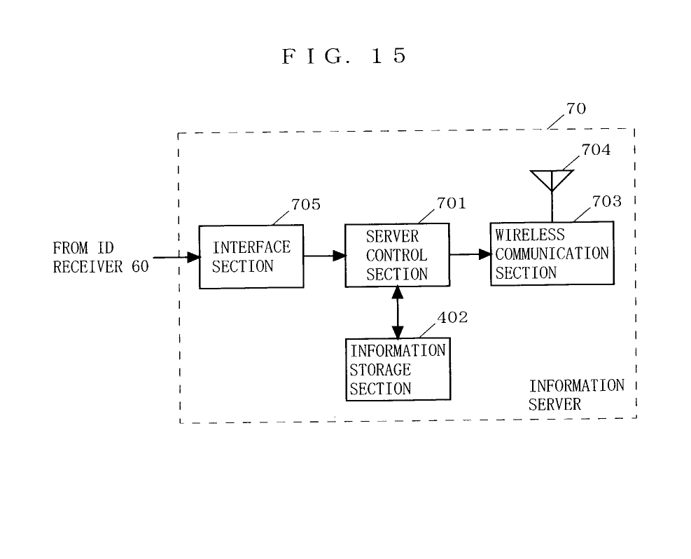

FIG. 15 is a block diagram showing the detailed structure of the information server 70 shown in FIG. 12. In FIG. 15, the information server 70 includes a server control section 701, the information storage section 402, a wireless communication section 703, a non-directivity antenna 704, and an interface section 705.

As shown in FIG. 15, the information server 70 of the second embodiment differs in all components from the information server 40 of the first embodiment, except in the information storage section 402. Hereinafter, the information server 70 is described, focusing on the components different from the counterparts of the information server 40 of the first embodiment.

The interface section 705 inputs the object ID and the device ID from the ID receiver 60. The server control section 701 receives the object ID and the device ID input from the interface section 705, extracts the source information of the object ID from the information storage section 402, and transmits the extracted source information to the image taking device 50 designated by the device ID. The wireless communication section 703 and the non-directivity antenna 704 transmit the source information to the image taking device 50 by wireless communication in accordance with the instruction from the server control section 701.

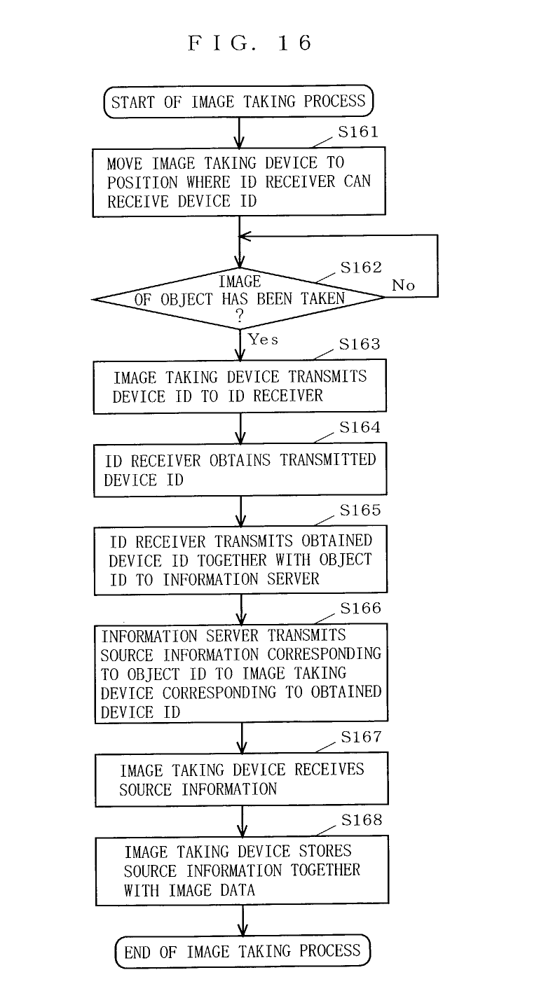

Next, an information acquisition method performed in the above-described information acquisition system according to the second embodiment is described. FIG. 16 is a flowchart showing a procedure of the information acquisition method according to the second embodiment of the present invention.

As in the case of the above-described first embodiment, the information server 70 realizes communication with the image taking device 50 by using wireless electric waves with no directivity and a long communication distance. Preferably, the wireless electric waves have output intensity suitable for covering the entire area of the exhibition site (see FIG. 6B).

A user carrying the image taking device 50 moves to the front of a specific object 20 for taking an image of the specific object 20, that is, he/she moves to a position where the device ID of the image taking device 50 can be received only by the ID receiver 60 provided to the specific object 20 (step S161).

After moving to a position where the ID receiver 60 can receive the device ID, the user performs an operation for taking an image of the object 20 (that is, the image of the object 20 has been taken at step S162). After the image of the object 20 is taken, the image taking device 50 sends the device ID stored in the storage section 502 to the ID receiver 60 (step S163). Typically, it is automatically determined that the image of the object 20 is taken when an image taking button (shutter) of the image taking device 50 is pressed, and the device ID is sent. The ID receiver 60 receives the device ID sent from the image taking device 50 (step S164). After the device ID is received from the image taking device 50, the ID receiver 60 transmits the received device ID together with its own object ID stored in the ID storage section 601 (step S165).

The information server 70 receives the object ID and the device ID from the ID receiver 60, and transmits the source information corresponding to the received object ID to the image taking device 50 designated by the received device ID (step S166). Note that the source information may be transmitted from the information server 70 to the image taking device 50 immediately after the information server 70 has received the object ID from the ID receiver 60, or may be transmitted at an appropriate time designated by the user after the image of the object 20 is taken. In the latter case, it is possible to collectively acquire the source information of a plurality of objects 20 whose images have already been taken.

The image taking device 50 designated by the device ID receives the source information from the information server 70 (step S167), and packages the encoded image data of the taken image with the source information for storing in the storage section 502 (step S168, see FIG. 9).

In the above-described embodiment, the case where the source information is transmitted and received without establishing a wireless communication path between the image taking device 50 and the information server 70 has been described. In this case, however, if the image taking device 50 fails to receive the source information, the image taking device 50 is assumed to be unable to acquire the source information. Therefore, as shown in FIG. 10, the source information may be transmitted and received after the wireless communication path is established between the image taking device 50 and the information server 70.

As described above, in the information acquisition system and the information acquisition method according to the second embodiment of the present invention, the ID receiver 60 provides only the object ID. Thus, the ID receiver 60 is required to have minimal amounts of memory suitable for storing only the object ID. Furthermore, the information server 70 does not store information directly related to the object 20, but stores information indicating a source where related information can be obtained, there by minimizing the amount of memory. Still further, the information server 70 collectively manages source information of a plurality of objects 20, thereby realizing space saving, cost reduction, and easy maintenance required when the source information is changed. Also, the source information is acquired when the image of the object 20 is taken. Thus, the user can obtain related information later if the remaining amount of memory of the image taking device 50 is insufficient, for example.

Note that, in the above-described second embodiment, the case where the device ID is transmitted from the image taking device 50 to the ID receiver 60 by infrared communication has been described, but the device ID may be transmitted by any form of wireless communication with directivity and a short communication distance. The above-described wireless communication can be easily realized by replacing the infrared transmitting section 506 and the infrared emitting element 507 of the image taking device 50 with a wireless communication section and a directivity antenna, respectively, and replacing the infrared receiving section 602 and the infrared receiving element 603 of the ID receiver 60 with a wireless communication section and a directivity antenna, respectively. In this case, if the image taking device 50 is allowed to appropriately switch its antenna between the non-directivity antenna 505 and the directivity antenna and control the transmitting and receiving sensitivity thereof, a single wireless communication section is sufficient for the device. Thus, it is possible to realize reduction of size and cost of the image taking device 50.

Furthermore, in the above-described second embodiment, the case where the information server 70 transmits the source information of the object 20 to the image taking device 50 has been described. As shown in FIG. 17, however, the following processing can be performed if the information server 70 is additionally provided with a network interface section 706 connecting the server control section 701 to a network.

When the image of the object 20 is taken, the image taking device 50 transmits a mail address of the user together with the device ID to the ID receiver 60. The information server 70 receives the object ID, the device ID, and the mail address from the ID receiver 60, and extracts the source information corresponding to the received object ID from the information storage section 402. Then, the information server 70 transmits the extracted source information to a device designated by the mail address via the network interface section 706. As a result, it is possible to transmit the source information to an arbitrary device such as a personal computer, or the like, via the network interface section 706. This is effective in the case where the amount of the related information is greater than the remaining amount of memory of the image taking device 50, or in the case where it takes a lot of time to complete acquisition of the related information due to slow communication speed of the image taking device 50, for example.

In the above-described second embodiment, the case where only the device ID is transmitted from the image taking device 50 to the information server 70 via the ID receiver 60 has been described. If a profile of the user of the image taking device 50 is additionally transmitted, the advertising effects described in the first embodiment also can be obtained.

(Third Embodiment)

The aforementioned first embodiment relates to the invention about acquisition of source information after the image taking device 10 is, for example, moved for designating a single object 20 from among a plurality of objects 20.

In the following third embodiment, a typical technique for designating a single object 20 when concurrently receiving the object ID from a plurality of objects 20 (that is, a plurality of ID transmitters 30) is described.

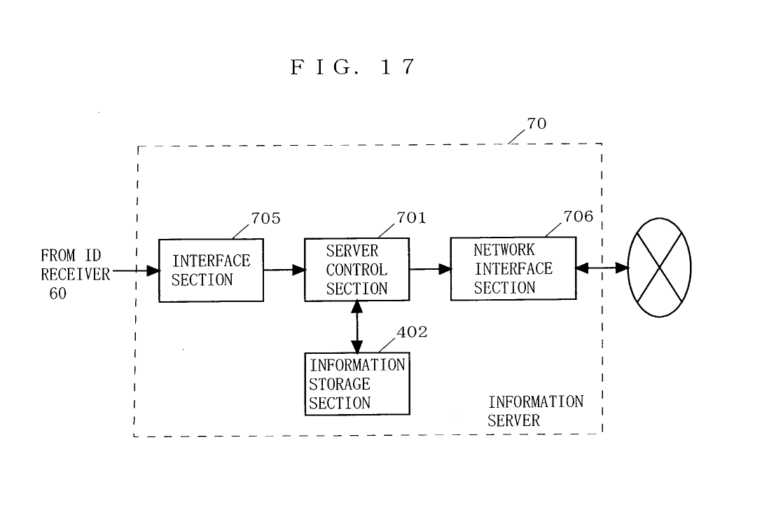

As shown in FIG. 18, assume that the image taking device 10 is placed at a position where concurrent reception of the object ID from three ID transmitters 30 is possible.

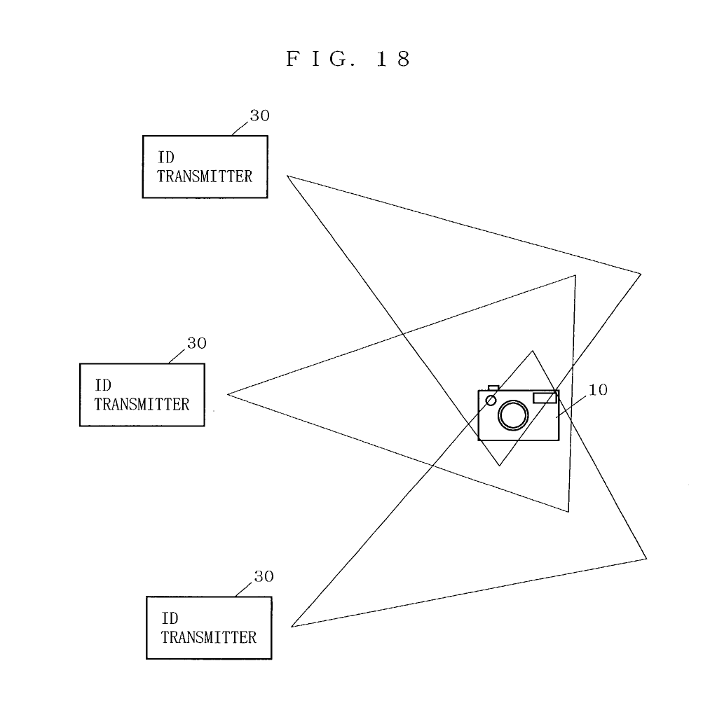

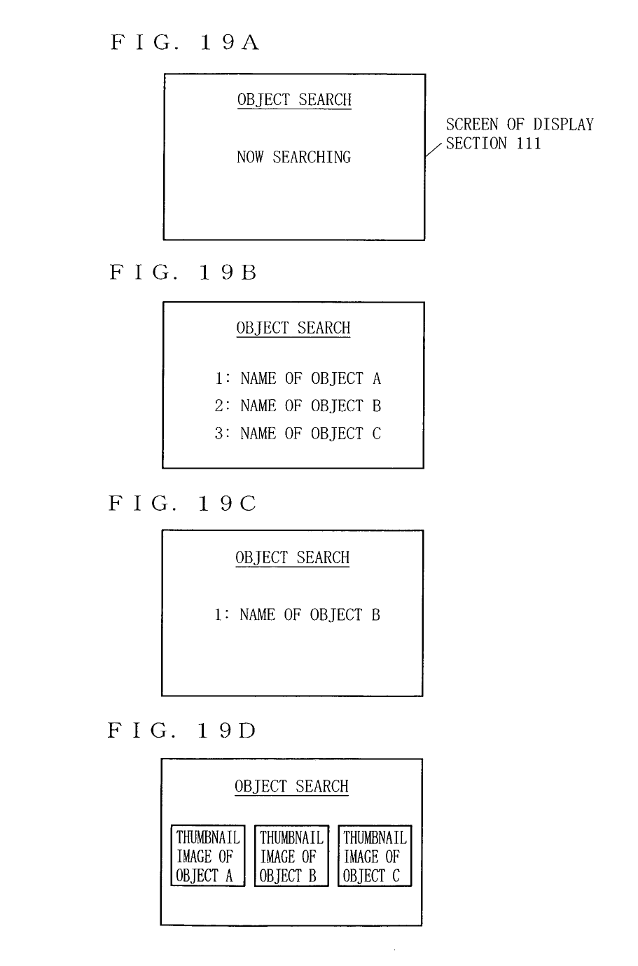

Before taking an image of the object 20, the image taking device 10 first detects any receivable object ID by the infrared receiving section 106. This detection may be performed based on the instruction from a user operating the key input section 103, or may be performed automatically according to a predetermined set cycle. When the detection of the object ID is started, the image taking device 10 causes the display section 111 to display a message saying “NOW SEARCHING” on the screen (For example, see FIG. 19A).

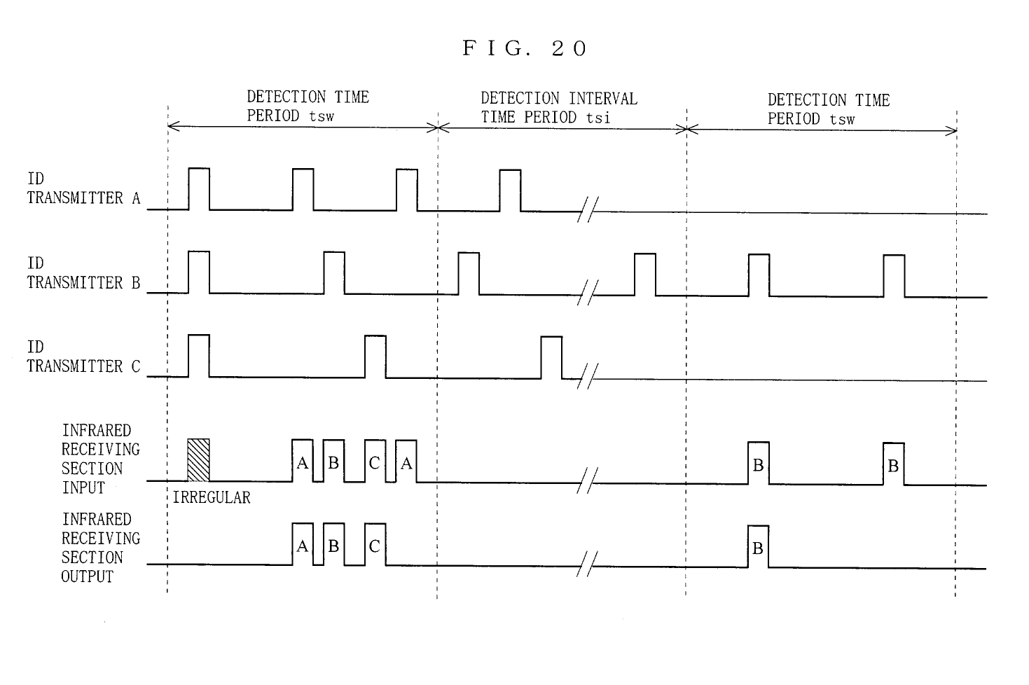

During a detection time period tsw previously set by the system, the infrared receiving section 106 receives the object ID, and causes the display section 111 to display on the screen all the objects 20 corresponding to the received object ID after a lapse of the detection time period tsw. As shown in FIG. 19B, names of the objects 20, for example, are displayed. The names to be displayed may be transmitted from the ID transmitter 30 together with the object ID. In the infrared communication, distinction is impossible if infrared rays sent from different sources are received at the same time. Thus, the infrared rays are preferably sent from each ID transmitter 30 at different intervals (FIG. 20). In this case, it is necessary to set the detection time period tsw at a value greater than the maximum value of the time interval required for transmitting the object ID from the ID transmitter 30. Furthermore, a detection interval time period tsi is set after the detection time period tsw for providing the user with time to designate the object 20.

After viewing a plurality of the objects 20 displayed on the screen of the display section 111, the user moves the image taking device 10 or changes its orientation during the detection interval time period tsi for selecting one of the displayed objects 20 or selecting another object 20 that is not displayed on the screen.

After a lapse of the detection interval time period tsi, the infrared receiving section 106 receives the object ID again during the next detection time period tsw, and causes the display section 111 to display the objects 20 corresponding to the received object ID on the screen after a lapse of the detection time period tsw.

During the next detection interval time period tsi, the user views one object 20 displayed on the screen of the display section 111 as shown in FIG. 19C, and executes processing for taking an image of the above-described one object 20. If a plurality of objects 20 are still displayed on the screen, the above-described processing is repeated. Note that, in the above-described embodiment, the next detection is started immediately after a lapse of the detection interval time period tsi, but it may be started in response to the instruction input from the key input section 103 by the user.

After a lapse of the detection time period tsw, thumbnail images of the objects 20 shown in FIG. 19D may be displayed on the screen display section 111. Data of the displayed thumbnail images may be transmitted from the ID transmitter 30 together with the object ID. In this case, the user selects one object 20 on the screen of the display section 111 without moving the image taking device 10 or changing the orientation thereof. The object ID of the selected object 20 is transmitted to the information server 40.

According to the object identification method of the above-described third embodiment, the user is allowed to view, on the display section 111, information about the object 20 whose object ID is being received. Thus, even if the object ID of a plurality of the objects 20 is being received, the user can reliably designate one desired object 20 with ease from among the plurality of the objects 20.

As described above, the information acquisition system, the information acquisition method, and the image taking device of the present invention are effective if specific information about an object item is desired to be acquired together with an image of the object item at an exhibition site, etc., where the object item is exhibited.

While the invention has been described in detail, the foregoing description is in all aspects illustrative and not restrictive. It is understood that numerous other modifications and variations can be devised without departing from the scope of the invention.

What is claimed is:

1. An information acquisition system that allows related information of an object, whose image has been taken, to be acquired from a predetermined information server, comprising:
at least one ID transmitter provided corresponding to at least one object for transmitting object identification information that enables unique identification of a corresponding object by a first communication method; and
an image taking device operable to take an image of one object among the at least one object, receive the object identification information transmitted from the ID transmitter while the image of the one object is taken, and acquire related information of the taken object, by using the received object identification information, from the predetermined information server by a second communication method.

2. The information acquisition system according to claim 1, wherein
the predetermined information server is connected to a predetermined network so as to be operable to communicate therewith;
the image taking device transmits the object identification information and a predetermined mail address of a user to the predetermined information server; and
the predetermined information server transmits the related information of the taken object to a device designated by the mail address via the network.

3. The information acquisition system according to claim 1, wherein the second communication method is performed by wireless communication with no directivity, and the first communication method is performed by infrared communication with directivity and a shorter communication distance compared to that of the second communication method.

4. The information acquisition system according to claim 1, wherein the second communication method is performed by wireless communication with no directivity, and the first communication method is performed by wireless communication with directivity and a shorter communication distance compared to that of the second communication method.

5. The information acquisition system according to claim 1, wherein the second communication method is performed by wireless communication with no directivity, and the first communication method is performed by wireless communication using a wireless tag, the wireless communication with no directivity and a shorter communication distance compared to that of the second communication method.

6. The information acquisition system according to claim 1, wherein the image taking device causes a predetermined mark, which indicates that the object identification information has been received from the ID transmitter, to be displayed on a screen.

7. The information acquisition system according to claim 1, wherein the image taking device causes predetermined information related to the object whose object identification information has been received from the ID transmitter to be displayed on a screen, and causes a user to input an instruction for selecting a piece of information from among the displayed information.

8. The information acquisition system according to claim 1, wherein the image taking device receives the object identification information transmitted from the ID transmitter when an image taking button for capturing an object image is operated by the user.

9. The information acquisition system according to claim 1, wherein the object identification information is source information providing an information source on a network where information related to the object is able to be acquired by the second communication method.

10. The information acquisition system according to claim 1, wherein
the at least one ID transmitter includes:
a storage section operable to store the object identification information; and
an information transmitting section operable to transmit the object identification information stored in the storage section to the image taking device by the first communication method, and
the image taking device includes:
an image obtaining section operable to take an image of a specific object in accordance with an image taking operation by a user;
an information receiving section operable to receive the object identification information of the specific object whose image has been taken by the image obtaining section from the ID transmitter provided to the specific object;
a request transmitting section operable to transmit the object identification information received by the information receiving section to the predetermined information server by the second communication method in accordance with a request from the user; and
a response receiving section operable to receive a response to transmission of the object identification information from the predetermined information server, and
the predetermined information server includes:
a storage section operable to store the related information of the object corresponding to the object identification information;
a request receiving section operable to receive the object identification information from the image taking device; and
a response transmitting section operable to transmit the related information of the object corresponding to the object identification information received by the request receiving section to the image taking device by the second communication method.

11. An image taking device that allows related information of an object whose image has been taken to be acquired from a predetermined information server, the image taking device operable to:
take an image of one object among at least one object;
receive object identification information transmitted by a first communication method from an ID transmitter provided corresponding to the one object, which enables unique identification of an object, while the image of the one object is taken; and
acquire related information of the taken object, by using the received object identification information, from the predetermined information server by a second communication method.

12. The image taking device according to claim 11, comprising:
an image obtaining section operable to take an image of a specific object in accordance with an image taking operation by a user;
an information receiving section operable to receive the object identification information of the specific object whose image has been taken by the image obtaining section from the ID transmitter provided to the specific object by the first communication method;
a request transmitting section operable to transmit the object identification information received by the information receiving section to the predetermined information server by the second communication method in accordance with a request from the user; and
a response receiving section operable to receive the related information of the object corresponding to the object identification information from the predetermined information server by the second communication method.

13. An information acquisition method executed in a system including an image taking device having an object image taking function and a predetermined communication function, at least one ID transmitter provided corresponding to at least one object, the at least one ID transmitter storing object identification information that enables unique identification of a corresponding object and having a function of transmitting the object identification information, and an information server storing related information of the object corresponding to the object identification information and having a predetermined communication function, the information acquisition method comprising:
a step of taking an image of a specific object by the image taking device in accordance with an image taking operation by a user;
a step of receiving the object identification information by the image taking device from the ID transmitter provided corresponding to the specific object by a first communication method while the image of the specific object is taken at the step of taking an image; and
a step of acquiring related information of the specific object, by using the received object identification information, by a second communication method from the information server by the image taking device in accordance with a request from the user.

14. A recording medium removably inserted into an image taking device that allows related information of an object whose image has been taken to be acquired from a predetermined information server, wherein
the image taking device is operable to:
take an image of one object among at least one object;
receive object identification information transmitted by a first communication method from an ID transmitter provided corresponding to the one object, which enables unique identification of an object, while the image of the one object is taken; and
acquire related information of the one object, by using the received object identification information, from the predetermined information server by a second communication method, and
the recording medium is operable to package image data of the one object whose image has been taken by the image taking device with the object identification information, and store the packaged image data and object identification information.
